(19) United States
(12) Patent Application Publication
(10) Pub. No.: US 2007/0083461 A1
(43) Pub. Date: Apr. 12, 2007

(54) Systems and methods for extending consumer credit and processing transactions

(75) Inventors: A. Hamid Andalib, Marietta, GA (US); David A. Barber, Hixson, TN (US); Brad J. Smrcina, Cleveland, TN (US); Jeffrey W. Grine, Chattanooga, TN (US); Stephen C. Smith, Signal Mountain, TN (US)

Correspondence Address: SMITH FROHWEIN TEMPEL GREENLEE BLAHA, LLC, Two Ravinia Drive, Suite 700, ATLANTA, GA, 30346, US

(73) Assignee: A. Hamid Andalib

(21) Appl. No.: 11/248,824

(22) Filed: Oct. 12, 2005

(51) Int. Cl. G06Q 40/00

(52) U.S. Cl. 705/38

(57) ABSTRACT

A method for extending consumer credit comprises identifying a consumer having a first line of credit and extending a second line of credit restricted for use with a designated merchant or merchant association under a consumer's account. In some embodiments, a risk abatement account is funded to pay uncollectible receivables of the credit provider created by the second line of credit. Other embodiments include incentives for one or both of use and timely payment(s) against the second line of credit. A system comprises a network, a management engine and an interface. The management engine associates a first line of credit and a second line of credit with a consumer account. The second line of credit is restricted to use with a designated merchant or association. When a consumer makes a purchase from the designated merchant(s), the management engine records the purchase transaction on the consumer's second line of credit.

These cards allow the purchase of goods and services, bill the consumer monthly and charge the consumer interest on unpaid balances. The consumer is sometimes asked to pay an annual fee as well. The credit provider generally provides different credit products, which include a card or cards and an associated account or line of credit. The credit provider sets an available credit limit depending upon the credit worthiness of the cardholder. The merchant or service provider pays an interchange fee based upon a percentage of the amount of the sale.

The second type of card is a charge card such as the American Express® series of cards. American Express® is the registered trademark of the American Express Company of New York, N.Y. These cards allow the user to charge purchases and services to the account. The customer is expected to pay the balance in full monthly. There is usually no interest charged. The limit on purchases is not usually geared to any set amount but based upon the user's usage history. There is an annual fee paid by the cardholder and the merchant pays a fee similar to the interchange fee based on the level of purchase. The American Express® fee paid by the merchant is usually higher than the typical bankcard interchange fee.

The third type of card is the “private label” credit card. A private label credit card is issued by or on behalf of a merchant. Private label credit cards are sometimes issued and serviced entirely by the merchant. Some other private label credit cards are issued and serviced by a financial institution. The financial transaction works very similar to a bank issued credit card. The private label credit card's use is usually limited to the merchant issuing/sponsoring the credit card. The private label card user may pay the monthly charges or partially pay the balance and pay interest on the unpaid balance as with a bank card. The merchant pays the financial institution a fee similar to the interchange fee associated with a bankcard. This fee is usually lower than the interchange fee with a bank card.

Consumers like the convenience of credit cards and like to take advantage of the services available from the various credit card services. However, consumer surveys reveal that consumers find themselves having too many credit cards. An advantage of the private label credit card is the availability of special promotional financing offers (such as “no interest for x months” promotions) and merchandise information from the issuer or associated merchant of the private label credit card. The primary advantage of the bank card is the almost universal acceptance world wide of a VISA® card, MasterCard®, or DISCOVER® card. These cards also typically have lower interest rates.

Banks and credit card companies desire to expand their account base by adding new consumers and by encouraging the use of credit. In 2004, the major credit card networks spent over $1 billion in advertising to promote the acceptance and increased use of credit card products. In addition, $4 billion was spent on direct marketing by credit card issuers such as American Express®, Bank of America®, Capital One®, MBNA®, DISCOVER® and Providian®. Bank of Americas is the registered trademark of Bank of America Corporation of Charlotte, N.C.; Capital One® is the registered trademark of Capital One Financial Corporation of Glen Allen, Va.; MBNA® is the registered trademark of Maryland Banking N.A. banking association of Newark, Del., and Providian® is the registered trademark of Providian Financial Corporation of San Francisco, Calif.

The credit card issuers and credit card processing networks achieved an average growth rate in credit volume of 12.8% annually in the fifteen year period starting in 1989. Despite the tremendous and growing demand for credit, the acceptance rate of new card offers is less than 1%. Consumers are relentlessly presented with direct mail solicitations for consumer credit. U.S. households receive an average of six credit card offers each month. These unsolicited direct mailings result in a positive response rate of one third of one percent (0.0033%). The consumer credit market is saturated with credit cards and credit card marketing concepts, such as, co-branding and reward/loyalty programs.

Current trends indicate that consumers are not interested in carrying more credit cards in order to enjoy reward incentives such as frequent flyer miles. These consumers would prefer higher credit limits to enable them to carry fewer cards. In direct conflict with consumer demand, credit providers are generally reluctant to issue more credit to a particular consumer than is warranted by one or more credit scoring models used to determine the risk to the provider.

U.S. Pat. No. 6,915,277 to Manchester et al. apparently describes a dual credit card system. The dual credit card can be used to make purchases at either a private label merchant location or at a location that accepts bank cards. When a purchase is made at a merchant location, the transaction is processed via a private label processing channel. If a purchase is made at a non-merchant location, the transaction is processed through the bank card network. However, routing and processing both private label merchant transactions and non-private label merchant transactions with the dual credit system apparently described in U.S. Pat. No. 6,915,277 does not address the above mentioned drawbacks with conventional consumer credit accounts.

Accordingly, despite the growth of consumer credit volume, services and products there is still a need for improved approaches for extending consumer credit.

### SUMMARY

An embodiment of a method for extending consumer credit comprises identifying a consumer having a first line of credit associated with a credit account and extending a second line of credit restricted for use with a designated merchant under the credit account.

Another embodiment of a method for extending consumer credit comprises selecting a set of consumers each having a respective first line of credit associated with a credit account, presenting an offer to extend a second line of credit to one or more of the set of consumers, wherein the second line of credit is restricted to use with a designated merchant, receiving an affirmative response to the offer and issuing the second line of credit to the consumer under the credit account.

An embodiment of a method for processing a purchase transaction with a consumer account is also invented and disclosed. The method comprises recording a purchase transaction from a merchant where the consumer uses an account having a single identifier associated with a first line of credit and a second line of credit and logging the purchase transaction into one of the first line of credit and the second line of credit depending on the identity of the merchant.

An alternative method for processing a purchase transaction comprises receiving consumer account information associated with a first line of credit and a second line of credit, wherein the second line of credit is restricted to transactions between the consumer and a merchant and forwarding, based on said consumer account information a portion of the amount of a purchase transaction to a risk abatement account.

Other methods for extending consumer credit comprise identifying a consumer having a first line of credit associated with a consumer account, the first line of credit being widely accepted at both domestic and foreign locations to make a purchase and extending a second line of credit restricted for purchases made via an online gift mall under the consumer account.

Related systems are also invented and disclosed. An embodiment of a system comprises a network, a management engine and an interface. The management engine and interface are coupled to each other and to the network. The management engine associates a first line of credit and a second line of credit with a consumer account. The second line of credit is restricted to use with a designated merchant. The interface receives consumer account information and purchase transaction information. When a consumer associated with the consumer account makes a purchase from the designated merchant, the purchase transaction information is recorded by the management engine on the consumer's second line of credit.

Other systems, methods, features and advantages will be or will become apparent to one with skill in the art upon examination of the following figures and detailed description. All such additional systems, methods, features and advantages are defined and protected by the accompanying claims.

### BRIEF DESCRIPTION OF THE FIGURES.

The systems and methods for extending consumer credit and processing transactions can be better understood with reference to the following figures. The functions within the various figures are not necessarily performed in the order presented, emphasis instead being placed upon clearly illustrating the principles used to extend consumer credit and processing transactions. Moreover, in the figures, like reference numerals designate corresponding parts throughout the different views.

FIG. 1 is a block diagram illustrating a system for extending consumer credit and processing transactions.

FIG. 2 is a flow diagram illustrating an embodiment of a method for extending consumer credit.

FIG. 3 is a flow diagram illustrating an extension to the method of FIG. 2.

FIG. 4 is a flow diagram illustrating an alternative extension to the method of FIG. 2.

FIG. 5 is a flow diagram illustrating an alternative embodiment of a method for extending consumer credit.

FIG. 6 is a flow diagram illustrating an extension to the method of FIG. 5.

FIG. 7 is a flow diagram illustrating an alternative extension to the method of FIG. 5.

FIG. 8 is a flow diagram illustrating an embodiment of a method for processing a purchase transaction.

FIG. 9 is a flow diagram illustrating an alternative embodiment of a method for processing a purchase transaction.

### DETAILED DESCRIPTION

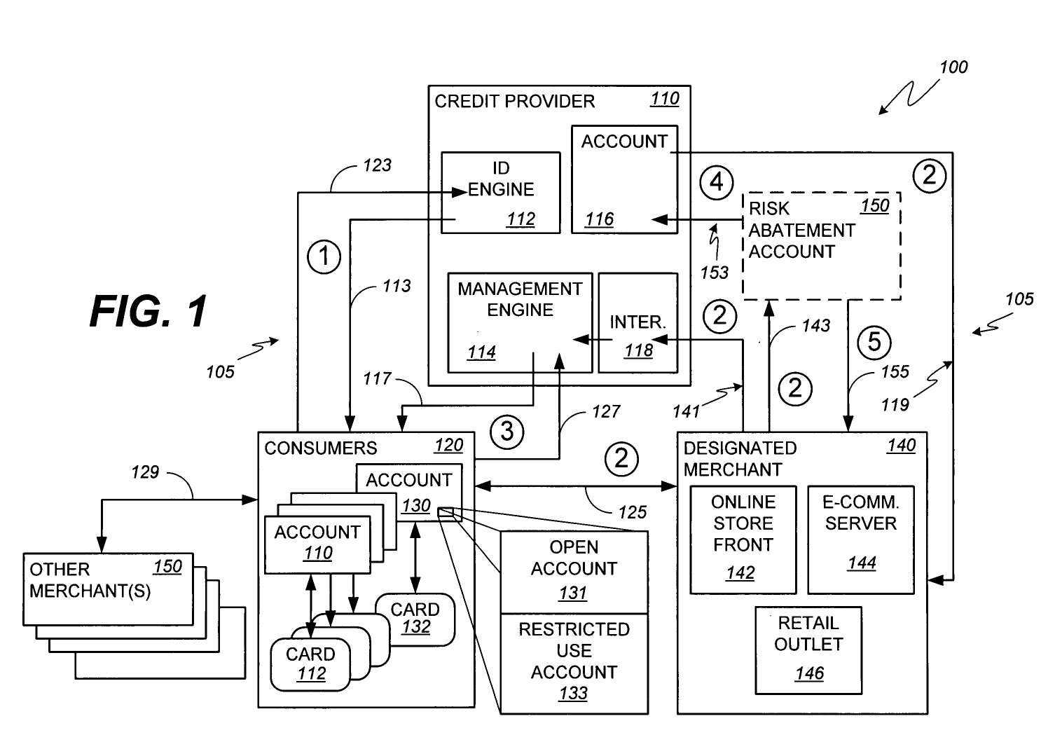

Various embodiments of systems and methods for extending consumer credit that combine a first line of credit with a second line of credit will be described with respect to FIGS. 1-9. With regard to described embodiments, the term “account” applies to any a record of debit and credit entries to cover transactions involving a particular item or a particular person or concern. Similarly, “consumer credit” is not limited to any particular type of payment mechanism, interest or no interest arrangement for balance amounts, usage fee or processing via a particular payment processing network. With regard to described embodiments, consumer accounts include at least a first line of credit that is open for use with all merchants other than a designated merchant willing to accept payment using an identifier associated with a particular consumer's account or an account that the presenter is authorized to use to engage in commerce and a second line of credit that is restricted to transactions with a designated merchant.

The following embodiments fulfill consumer demand for additional credit, while reducing both acquisition and marketing expenditures for credit providers. In addition, some of the following embodiments describe steps to mitigate and offset bad debt incurred through the use of the restricted line of credit, while creating an additional revenue source for designated merchants. Consumers are offered a second line of credit to use for purchasing goods and services from a designated merchant or from an association of merchants via an online mall. In some embodiments, the restricted line of credit is used for online purchases from designated merchants associated with a virtual mall accessible via a wide-area network. For example, designated merchants may be merchants associated and accessible to consumers via an online gift mall at uniform resource locator www.vipgiftmall.com. The virtual mall exposes multiple merchants to consumers that can use their dual credit lines to purchase goods or services. In other embodiments, the designated merchant operates a retail store or both retail and virtual stores.

In other embodiments, the designated merchant or merchant association establishes a risk abatement account. The risk abatement account is funded through proceeds from sales to consumers that use their respective second lines of credit to purchase goods and services of the designated merchant or the merchant association (e.g., merchants that are accessible online via www.vipgiftmall.com).

Some embodiments provide incentives for consumer use of the second line of credit. Contemplated incentives are intended to foster new account generation, extend additional credit to the account holder, while increasing sales for designated merchants.

In addition, incentives are provided to reward desired consumer behaviors. By way of example, consumers can earn points for agreeing to open the second line of credit, making on time payments, purchasing goods and services of select merchants, signing up for automatic payments, and making a series of consecutive timely payments.

The above described consumer account with open and restricted lines of credit will stimulate growth in credit acquisition, account retention and accounts receivable. In one embodiment, a consumer credit product comprises a first line of credit for purchases via a bank card network accepted at millions of locations worldwide and a second line of credit used exclusively for purchases made online via VIPGiftMall™.

Having described the general operation of an exemplary method for extending consumer credit, various additional embodiments will be described with respect to FIGS. 1-9. FIG. 1 is a block diagram illustrating an embodiment of system 100 that provides an infrastructure for extending credit and processing transactions. As illustrated in FIG. 1, credit provider 110, consumers 120 and designated merchant 140 are coupled via network 105.

Credit provider 110 comprises identification engine 112, management engine 114, account 116 and interface 118. Identification engine 112 includes logic that identifies present consumer credit account holders that are candidates for additional credit. Specifically, consumers 120 likely to be receptive to an offer for a second line of credit that is restricted to use with designated merchant 140. Identification engine 112 communicates an offer via connection 113 over network 105 to one or more consumers 120. In turn, consumers 120 communicate their acceptance via connection 123 over network 105 or consumers 120 communicate their acceptance via alternative communication channels, such as mail. These preliminary steps of communicating an offer and an acceptance are labeled with an encircled “1.”

Consumers 120 hold respective accounts. For example, account 110 is associated with a card 112. Card 112 is configured with information. Card 112 is configured with at least one identifier that is associated with account 110. The information, including the identifier, is encoded on a magnetic strip, flash memory, or other method that is readable by a suitably configured point-of-purchase terminal. In some embodiments, the identifier and the card holder's name are observable on one or more surfaces of card 112. Account 130 is representative of a multiple account in accordance with the disclosed methods for extending consumer credit and processing transactions. Account 130 includes a first open account 131 and a second restricted use account 133. Open account 131 is used by the consumer that holds account 130 to purchase goods and services from other merchants 150. Consumers 120 communicate with other merchants via connection 129. In the illustrated embodiment, connection 129 is an online connection via a wide area network. In alternative embodiments, consumers 120 present the card at a retail location or other point of sale to initiate a purchase transaction with a merchant (other merchants 150) other than designated merchant 140.

Designated merchant 140 comprises online store front 142, e-commerce server 144 and optionally, retail outlet 146. Consumers 120 communicate with designated merchant 140 over network 105 via connection 125 and online store front 142 to purchase goods or services. E-commerce server 144 communicates with credit provider 110 via connection 141 and interface 118 to record purchase transactions. Alternatively, consumers 120 visit retail outlet 146 to purchase goods or services in person. Regardless of whether consumers 120 communicate with designated merchant 140 online or visit a retail outlet to make a purchase, when a respective consumer 120 elects to pay for the purchase with account 130, the transaction will be recorded by credit provider 110 against restricted use account 133. Interface 118 receives the communication including the purchase transaction information from designated merchant 140.

Transaction information is communicated from interface 118 to management engine 114 where it is stored. In accordance with the transaction information, credit provider 110 transfers funds from account 116 to designated merchant 140 over network 105 via connection 119. In association with the purchase transaction designated merchant 140 transfers a portion of the receipts to risk abatement account 150 via connection 143. In some arrangements, designated merchant 140 transfers a percentage of the amount of sales “charged” via restricted use account 133. In other arrangements, designated merchant 140 transfers a percentage of profits attributable to sales “charged” via restricted use account 133. Regardless of the function used to fund risk abatement account 140, the funds that accumulate therein are available to offset losses of credit provider 110 attributable to uncollectible receivables from restricted use account 133. These steps of communicating to initiate and record a purchase transaction, forwarding finds to designated merchant 140 on behalf of consumer 120 and transferring finds into risk abatement account 150 are labeled with an encircled “2.”

Thereafter, management engine 114 issues a statement of all transactions against each consumer account. Accordingly, the statement issued to account 130 includes a list of all transactions logged against open account 131 (i.e., transactions with other merchants 150) since the last statement as well as a list of all transactions logged against restricted use account 133 (i.e., transactions between consumer 120 and designated merchant 140. The statement is communicated over network 105 via connection 117. In response to the periodic statement, consumer 120 issues a payment of at least a portion of the outstanding balance of open account 131 and restricted use account 133. The payment is communicated over network 105 via connection 127. Alternatively, credit provider 110 generates and mails a hard copy statement to consumer 120. In this alternative mode of operation, consumer 120 returns a portion of the statement along with a draft or money order to the credit provider 110. These steps of communicating a periodic statement and making a payment are labeled with an encircled “3.”

One or more consumers 120 may fail to make a minimum payment against restricted use account 133. When it is determined that the restricted use account 133 is uncollectible, credit provider 110 communicates over network 105 via connection 153 the amount of the debt, the debtor and closes restricted use account 133. In return, the holder of risk abatement account 150 reimburses credit provider 110 for the unrecoverable receivable. These steps of communicating information regarding an uncollectible receivable and making a payment to reimburse credit provider 110 are labeled with an encircled “4.”

Over time, risk abatement account 150 may increase at a rate that exceeds the credit provider's uncollectible receivables. When this is the case, one or more return payments are forwarded via connection 155 to designated merchant 140. Alternatively, designated merchant 140 can adjust the rate at which payments are forwarded to risk abatement account 150 until the designated merchant's payments into the account approximate the rate of reimbursement payments out of risk abatement account 150. This optional step of forwarding a return payment from risk abatement account 150 to designated merchant 140 is labeled with an encircled “5.”

In the illustrated embodiment, the risk abatement account 150 is shown as being removed from both credit provider 110 and designated merchant 140. In this arrangement a trustee controls the risk abatement account 150. However, it is contemplated that the risk abatement account 150 can be managed or otherwise controlled by credit provider 110 or designated merchant 140. These alternative arrangements could be supervised by the non-controlling party and or some other third party.

In the illustrated embodiment, identification engine 112 associated with the credit provider 110 identifies one or more consumers 120 that are candidates to receive an offer for a second line of credit that is restricted to use with designated merchant 140. Accordingly, in this embodiment credit provider 110 communicates the offer to consumer(s) 120. However, it should be understood that alternatively an offer to extend a second line of credit restricted to transactions with designated merchant 140 could be initiated by designated merchant 140 and communicated to credit provider 110 for approval before being presented to consumer(s) 120. Moreover, it should be understood that designated merchant 140 could approach consumer(s) 120 with an offer to support such an arrangement with credit provider 110. In these alternative embodiments, consumer(s) 120 could be presented with a request form to complete and communicate to credit provider 110 should they elect to apply for the additional line of credit.

Moreover, it should be understood that designated merchant 140 can be replaced by an association of merchants. In one alternative embodiment, designated merchant 140 is replaced by a virtual mall that is accessible to consumers 120. The virtual mall exposes the goods and/or services of one or more merchants to consumers 120. The virtual mall is hosted on one or more servers coupled to the publicly accessible wide area network commonly known as the Internet. When online, one or more consumers 120 access the virtual mall via a uniform resource locator. Alternatively, one or more call centers may be configured to accept calls from consumers 120 intending to purchase goods and/or services from virtual mall merchants. In this alternative embodiment, consumers 120 contact and communicate with virtual mall via one or more networks using one or more identifiers associated with the virtual mall call centers. Regardless of the network infrastructure and methods used for communicating with virtual mall merchants or their representatives, when consumers 120 make purchases from virtual mall merchants, the purchase amount is logged against restricted use account 133. In some embodiments, the one or more servers and/or call center computers are configured to confirm a particular consumer's current account status before the consumer 120 is permitted to make a purchase. When the current account status indicates that the consumer 120 has failed to make a timely payment or when the total of an open account balance and a restricted account balance exceed the credit provider's business rules, the consumer 120 may be denied additional credit. Otherwise, when the current account status indicates that the consumer 120 is in good standing (e.g., timely with payments and within maximum credit limits set by credit provider 110), the consumer 120 is communicated a maximum funds available amount in accordance with one or more credit provider rules. Thereafter, the consumer 120 is free to browse through the online catalogs of the virtual mall and purchase goods and/or services up to the maximum funds available.

Online catalogs associated with one or more merchant members of the virtual mall present a host of information to consumer 120. The information includes a description of the good or service offered, a purchase price, as well as an installment rate and term. The online catalogs further include a mechanism for the consumer 120 to select one of the purchase now price and the installment rate and term. Whether the consumer 120 elects to make the purchase using the purchase now price or the consumer 120 elects to make the purchase by paying a minimum installment on a periodic basis, the purchase transaction is recorded against the restricted use account 133.

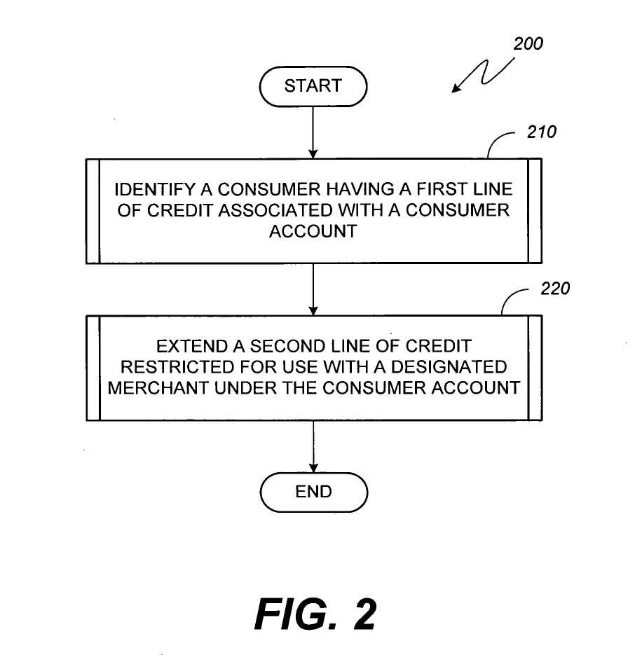

The flow diagram of FIG. 2 shows the architecture, functionality, and operation of a possible implementation via software and or firmware associated with communicatively coupled hardware devices in example system 100. In this regard, each block represents a module, segment, or portion of code, which comprises one or more executable instructions for implementing the specified function(s). Method 200 begins with block 210 where a consumer having a first line of credit associated with a consumer account is identified. As indicated in block 220, a second line of credit restricted for use with a designated merchant is extended to the consumer under the consumer's account.

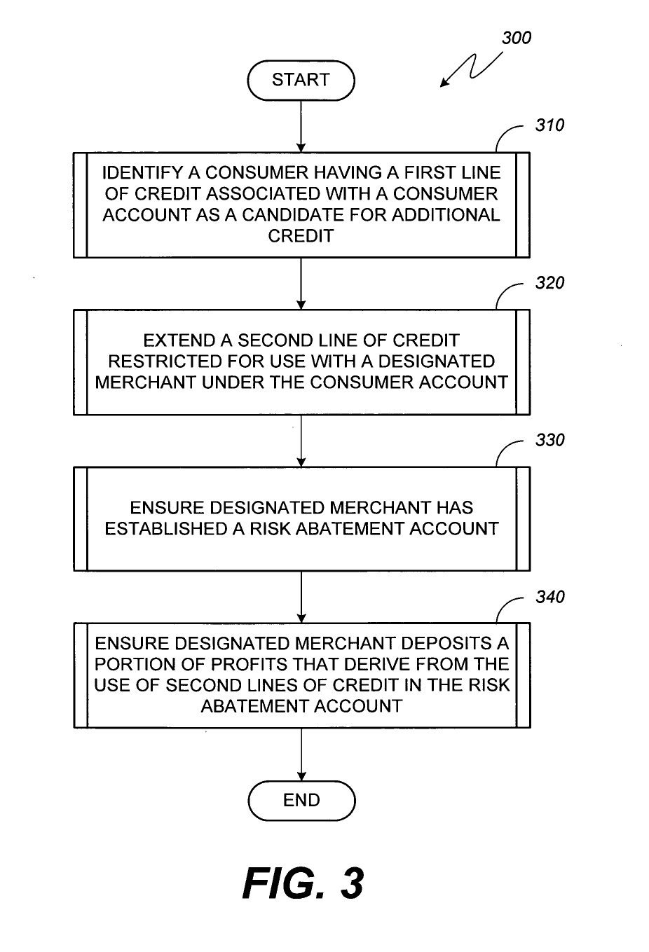

The flow diagram of FIG. 3 shows the architecture, functionality, and operation of a possible implementation via software and or firmware associated with communicatively coupled hardware devices in example system 100. In this regard, each block represents a module, segment, or portion of code, which comprises one or more executable instructions for implementing the specified function(s). Method 300 begins with block 310 where a consumer having a first line of credit associated with a consumer account is identified as a candidate for receiving an additional line of credit. As indicated in block 320, a second line of credit restricted for use with a designated merchant is extended to the consumer under the consumer's account. In block 330, a risk abatement account is established on behalf of the designated merchant. Thereafter, as indicated in block 340, the designated merchant deposits a portion of the receipts from the use of the second line of credit in the risk abatement account.

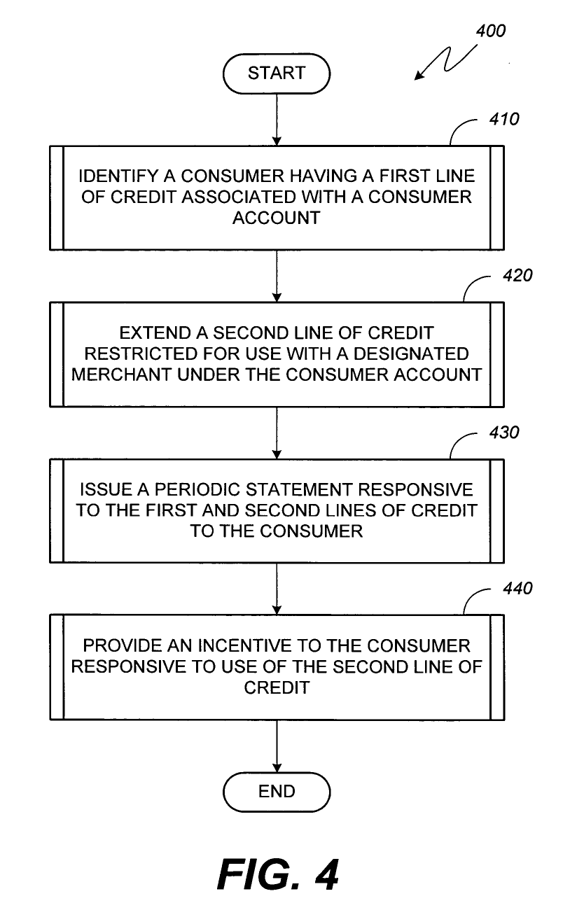

The flow diagram of FIG. 4 shows the architecture, functionality, and operation of a possible implementation via software and or firmware associated with communicatively coupled hardware devices in example system 100. In this regard, each block represents a module, segment, or portion of code, which comprises one or more executable instructions for implementing the specified function(s). Method 400 begins with block 410 where a consumer having a first line of credit associated with a consumer account is identified as a candidate for receiving an additional line of credit. As indicated in block 420, a second line of credit restricted for use with a designated merchant is extended to the consumer under the consumer's account. In block 430, a periodic statement responsive to the first and second lines of credit is issued to the consumer. Thereafter, as indicated in block 440, an incentive to use the second line of credit is provided to the consumer.

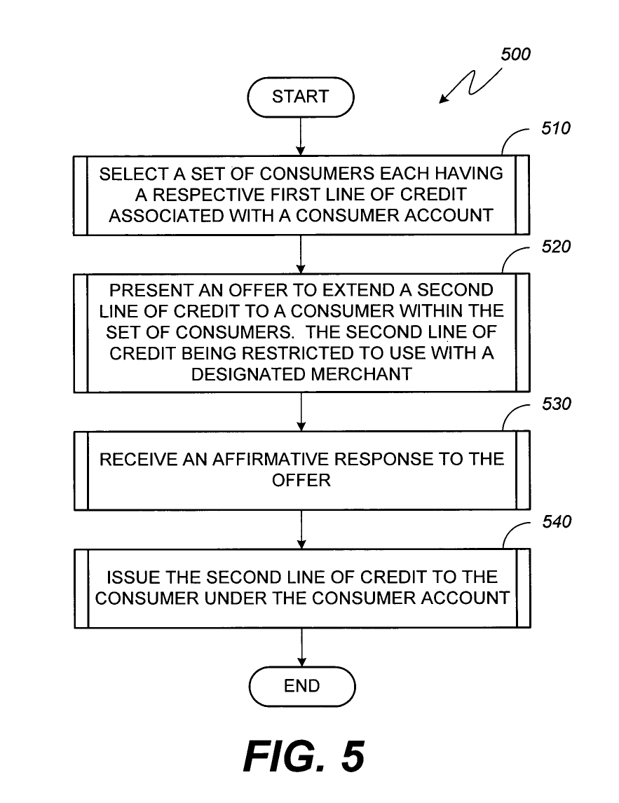

The flow diagram of FIG. 5 shows the architecture, functionality, and operation of a possible implementation via software and or firmware associated with communicatively coupled hardware devices that enable a credit provider to identify consumers, present an offer for additional credit, respond to an acceptance of the offer and manage the account via example system 100. In this regard, each block represents a module, segment, or portion of code, which comprises one or more executable instructions for implementing the specified function(s). Method 500 begins with block 510 where a credit provider selects a set of consumers with respective credit lines associated with a consumer account. Thereafter, as indicated in block 520, the credit provider presents an offer to extend a second line of credit that is restricted to use with a designated merchant to a consumer from the set of consumers. In block 530 the credit provider receives an affirmative response to the offer. In response, the credit provider issues the second line of credit to the consumer under the consumer account, as indicated in block 540.

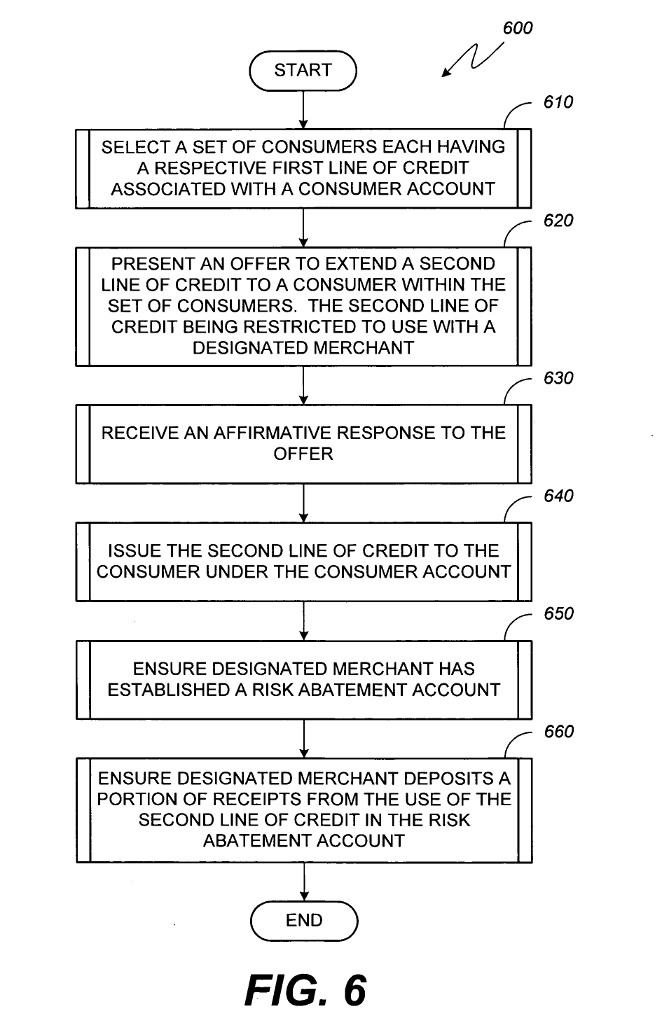

The flow diagram of FIG. 6 shows the architecture, functionality, and operation of a possible implementation via software and or firmware associated with communicatively coupled hardware devices that enable a credit provider to identify consumers, present an offer for additional credit, respond to an acceptance of the offer and manage the account via example system 100. In this regard, each block represents a module, segment, or portion of code, which comprises one or more executable instructions for implementing the specified function(s). Method 600 begins with block 610 where a credit provider selects a set of consumers with respective credit lines associated with a consumer account. Thereafter, as indicated in block 620, the credit provider presents an offer to extend a second line of credit that is restricted to use with a designated merchant to a consumer from the set of consumers. In block 630 the credit provider receives an affirmative response to the offer. In response, the credit provider issues the second line of credit to the consumer under the consumer account, as indicated in block 640. In block 650, the credit provider ensures that the designated merchant has established a risk abatement account. Thereafter, in block 660, the credit provider ensures that the designated merchant deposits a portion of receipts from use of the second line of credit in the risk abatement account.

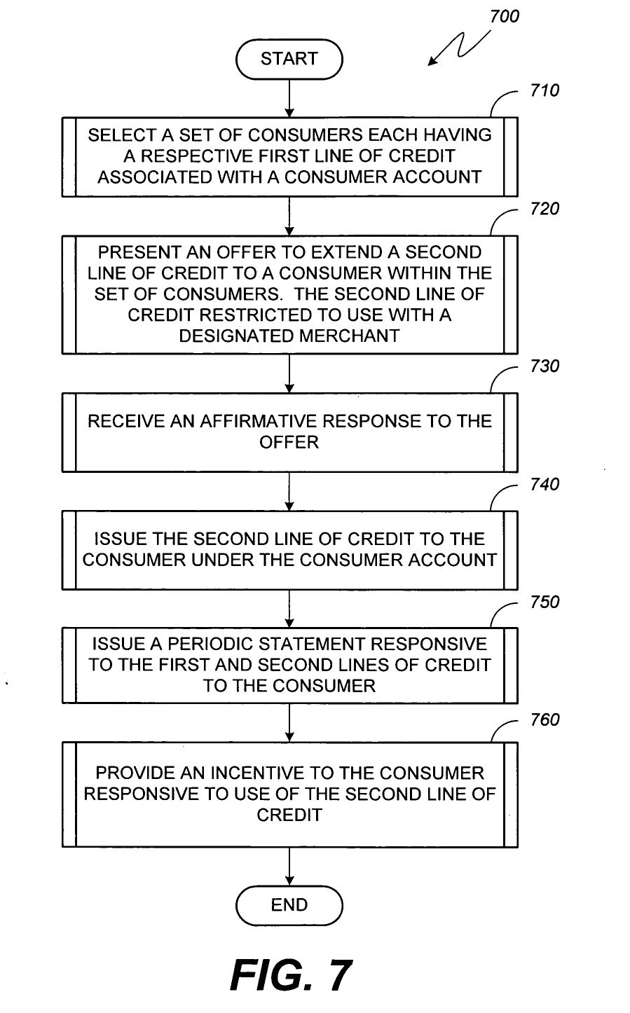

The flow diagram of FIG. 7 shows the architecture, functionality, and operation of a possible implementation via software and or firmware associated with communicatively coupled hardware devices that enable a credit provider to identify consumers, present an offer for additional credit, respond to an acceptance of the offer and manage the account via example system 100. In this regard, each block represents a module, segment, or portion of code, which comprises one or more executable instructions for implementing the specified function(s). Method 700 begins with block 710 where a credit provider selects a set of consumers with respective credit lines associated with a consumer account. Thereafter, as indicated in block 720, the credit provider presents an offer to extend a second line of credit that is restricted to use with a designated merchant to a consumer from the set of consumers. In block 730 the credit provider receives an affirmative response to the offer. In response, the credit provider issues the second line of credit to the consumer under the consumer account, as indicated in block 740. Periodically thereafter, the credit provider issues a statement responsive to the first and second lines of credit to the consumer, as shown in block 750. As indicated in block 760, the credit provider includes an incentive responsive to the consumer's use of the second line of credit.

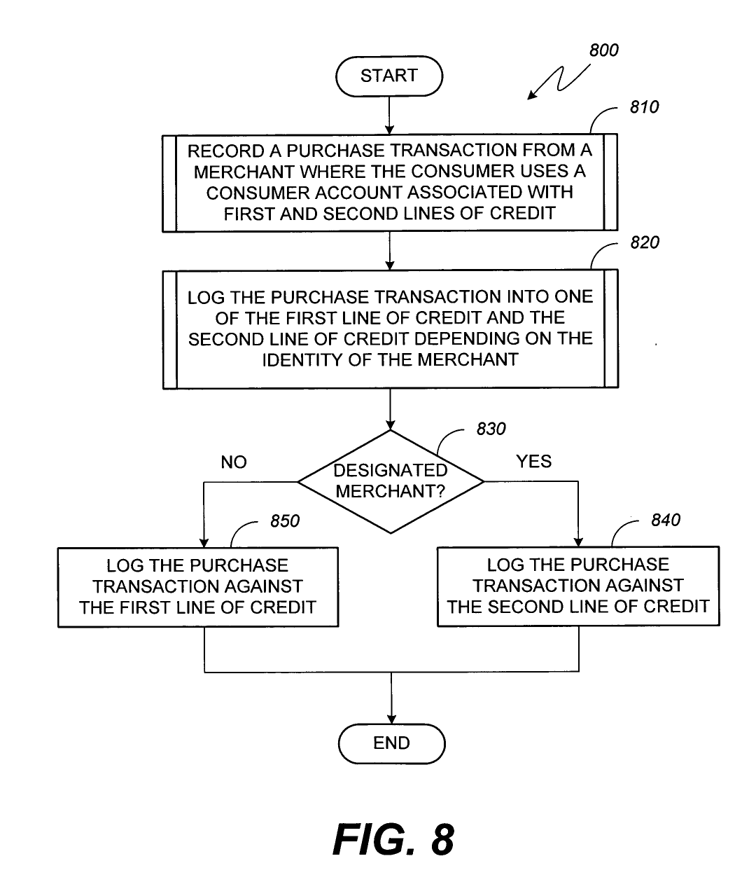

The flow diagram of FIG. 8 shows the architecture, functionality, and operation of a possible implementation via software and or firmware associated with communicatively coupled hardware devices that enable a credit provider to record a purchase transaction via example system 100. In this regard, each block represents a module, segment, or portion of code, which comprises one or more executable instructions for implementing the specified function(s). Method 800 begins with block 810 where a credit provider records a purchase transaction from a merchant where the consumer uses a consumer account associated with first and second lines of credit. Next, as indicated in block 820, the credit provider logs the purchase transaction into one of the first line of credit and the second line of credit depending on the identity of the merchant. A determination is made as illustrated in decision block 830 whether the transaction is made with a designated merchant. When the transaction is with a designated merchant, the credit provider logs the purchase transaction against the second line of credit, as shown in block 840. Otherwise, when the transaction is with a merchant other than the designated merchant associated with the second line of credit, the credit provider logs the purchase transaction against the first line of credit, as shown in block 850.

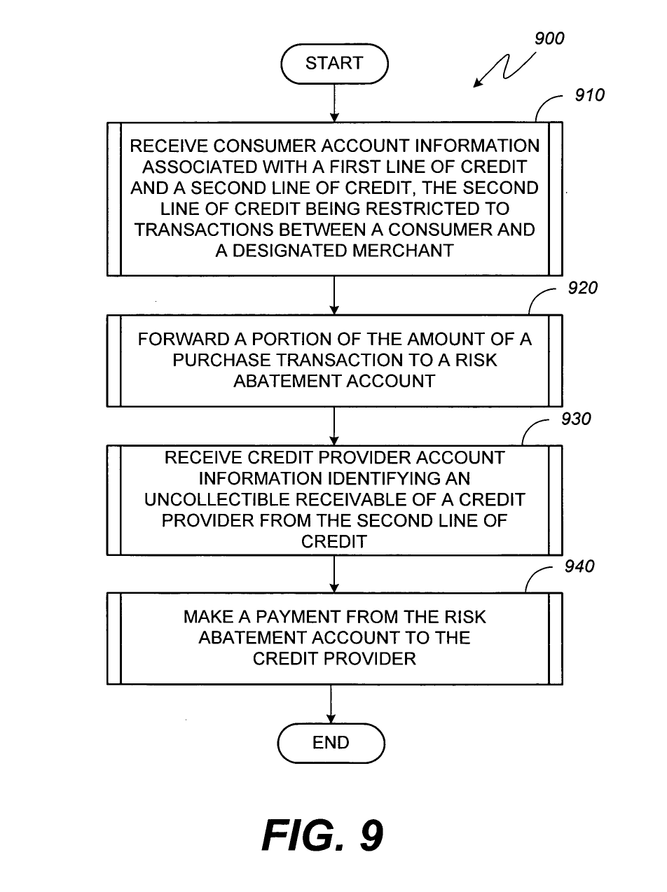

The flow diagram of FIG. 9 shows the architecture, functionality, and operation of a possible implementation via software and or firmware associated with a host of communicatively coupled hardware devices that enable the integration of a merchant, a risk abatement account and a credit provider via example system 100. In this regard, each block represents a module, segment, or portion of code, which comprises one or more executable instructions for implementing the specified function(s). Method 900 begins with block 910 where a merchant receives consumer account information associated with a first line of credit and a second line of credit that is restricted to transactions between a consumer and a designated merchant. In block 920, a designated merchant forwards a portion of the amount of a purchase transaction to a risk abatement account. Thereafter, as indicated in block 930, a designated merchant or trustee of the risk abatement account receives credit provider account information identifying an uncollectible receivable of a credit provider from the second line of credit. In block 940 the designated merchant or trustee of the risk abatement account makes a payment from the risk abatement account to the credit provider.

The operational software programs that may be used by the various devices of the system 100, as well as operational software that may be used in conjunction with browsers, telephonic devices, personal digital assistants, point-of-sale communication terminals, and applications that interface with system 100, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device.

The computer-readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and then stored in an accessible memory.

While various embodiments of the systems and methods for extending consumer credit and processing transactions have been described, it will be apparent to those of ordinary skill in the art that many more embodiments and implementations are possible that are within the scope of the accompanying claims. Accordingly, the systems and methods for extending consumer credit and processing transactions are not to be restricted beyond the attached claims and their equivalents.

What is claimed is:

1. A method for extending consumer credit, the method comprising:
identifying a consumer having a first line of credit associated with a consumer account; and
extending a second line of credit restricted for use with a designated merchant under the consumer account.

2. The method of claim 1, further comprising:
receiving funds from a risk abatement account.

3. The method of claim 2, wherein the risk abatement account is funded in accordance with a function of the receipts of the designated merchant attributable to use of the second line of credit.

4. The method of claim 3, wherein the function comprises a fixed percentage of the profits of the designated merchant attributable to use of the second line of credit.

5. The method of claim 1, further comprising:
issuing a monthly statement responsive to the first line of credit and the second line of credit to the consumer.

6. The method of claim 5, wherein the monthly statement comprises an incentive.

7. The method of claim 6, wherein the incentive is responsive to use of the second line of credit.

8. The method of claim 6, wherein the incentive is responsive to timely payment.

9. The method of claim 1, wherein extending a second line of credit is responsive to a consumer request.

10. The method of claim 1, wherein the designated merchant operates an electronic commerce site accessible via a network, the electronic commerce site configured to present alternative purchase payment options.

11. A method for extending consumer credit, the method comprising:
selecting a set of consumers each having a respective first line of credit associated with a consumer account;
presenting an offer to extend a second line of credit to one or more of the set of consumers, wherein the second line of credit is restricted to use with a designated merchant;
receiving an affirmative response to the offer; and
issuing the second line of credit to the consumer under the consumer account.

12. The method of claim 11, wherein selecting a set of proposed consumers is responsive to a consumer credit usage statistic.

13. The method of claim 1 1, further comprising:
communicating the second line of credit to the designated merchant.

14. The method of claim 13, further comprising:
receiving information responsive to a risk abatement account.

15. The method of claim 14, wherein the risk abatement account is established with a party other than a credit provider and the designated merchant.

16. The method of claim 14, wherein the risk abatement account is funded by the designated merchant in accordance with a function of the receipts from purchase transactions under the second line credit.

17. The method of claim 14, wherein the risk abatement account is debited to pay the credit provider for uncollectible receivables.

18. The method of claim 11, wherein the designated merchant operates an electronic commerce site accessible via a network the electronic commerce site configured to present a purchase now amount and an installment rate and term.

19. The method of claim 11, further comprising:
offering an incentive to the consumer for use of the second line of credit.

20. The method of claim 19, wherein the incentive is responsive to timely payments made to the second line of credit.

21. A system, comprising:
a network;
a management engine coupled to the network and configured to associate a first line of credit and a second line of credit with a consumer account, wherein the second line of credit is restricted to use with a designated merchant; and
an interface coupled to the network and the management engine, the interface configured to receive consumer account and purchase transaction information, wherein when a consumer makes a purchase from the designated merchant, the purchase transaction information is recorded by the management engine on the consumer's second line of credit.

22. The system of claim 21, further comprising:
an identification engine coupled to the network and configured to identify one or more additional consumers having a first line of credit associated with a respective consumer account that should be presented with an offer for the second line of credit.

23. The system of claim 21, further comprising:
a risk abatement account funded by the designated merchant.

24. The system of claim 23, wherein the designated merchant deposits funds in the risk abatement account in accordance with a function of purchase transaction information.

25. The system of claim 21, wherein said management engine is further configured to offer an incentive to the consumer in exchange for the consumer's agreement to open the second line of credit.

26. The system of claim 25, wherein said management engine is further configured to offer an incentive to the consumer in accordance with the consumer's use of the second line of credit.

27. The system of claim 26, wherein use of the second line of credit comprises a timely payment.

28. The system of claim 26, wherein use of the second line of credit comprises a series of consecutive timely payments.

29. The system of claim 26, wherein use of the second line of credit comprises the consumer agreeing to make periodic automatic payments.

30. A method, comprising:
recording a purchase transaction from a merchant wherein the consumer uses a consumer account having a single identifier associated with a first line of credit and a second line of credit; and
logging the purchase transaction into one of the first line of credit and the second line of credit depending on the identity of the merchant.

31. The method of claim 30, wherein logging the purchase transaction comprises making an entry in the second line of credit when the merchant is a designated merchant.

32. The method of claim 30, wherein logging the purchase transaction comprises making an entry in the first line of credit when the merchant is an entity other than a designated merchant.

33. A method, comprising:
receiving, by a merchant, consumer account information associated with a first line of credit and a second line of credit, wherein the second line of credit is restricted to transactions between the consumer and the merchant; and
forwarding, based on said consumer account information, a portion of the amount of a purchase transaction to a risk abatement account.

34. The method of claim 33, further comprising:
receiving, by a merchant, credit provider account information identifying an uncollectible receivable of a credit provider from the second line of credit; and
making a payment from the risk abatement account to the credit provider.

35. A method for extending consumer credit, the method comprising:
identifying a consumer having a first line of credit associated with a consumer account, wherein the first line of credit is accepted at one or more locations to make a purchase; and
extending a second line of credit restricted for use with an online gift mall under the consumer account.

36. The method of claim 35, further comprising:
receiving funds from a risk abatement account.

37. The method of claim 36, wherein the risk abatement account is funded in accordance with a function of the receipts of one or more vendors associated with the online gift mall.

38. The method of claim 35, further comprising communicating an incentive to the consumer.

39. The method of claim 38, wherein the incentive is awarded in response to use of the second line of credit.

40. The method of claim 35, wherein the online gift mall exposes one or more merchants to a holder of the consumer account.
